(19) United States
(12) Patent Application Publication
(10) Pub. No.: US 2013/0088466 A1
(43) Pub. Date: Apr. 11, 2013

(54) APPARATUS AND METHOD FOR ENABLING VIEWER TO PERCEIVE THREE DIMENSIONAL IMAGE

(71) Applicant: Ryota ODAKE, Suwon-Si (KR)

(72) Inventor: Ryota ODAKE, Suwon-Si (KR)

(73) Assignee: SAMSUNG DISPLAY CO., LTD., Yongin City (KR)

(21) Appl. No.: 13/560,799

(22) Filed: Jul. 27, 2012

(30) Foreign Application Priority Data
Oct. 7, 2011 (KR) 10-2011-0102357

(51) Int. Cl. G06F 3/038

(52) U.S. Cl. 345/204

(57) ABSTRACT

A display apparatus enables a viewer to perceive a three-dimensional image. The display apparatus includes a display panel. The display apparatus further includes a display panel driver for providing first image data to the display panel during a first sub-frame and for providing second image data to the display panel during a second sub-frame. The display apparatus further includes a barrier part that includes a plurality of barriers for adjusting presentation of a two-dimensional image displayed on the display panel to enable the viewer to perceive the three-dimensional image, the plurality of barriers including a first barrier and a second barrier neighboring the first barrier. The display apparatus further includes a barrier driver for controlling the barrier part so that the first barrier permits transmission of first light during the first sub-frame and so that the second barrier permits transmission of second light during the second sub-frame.

### CROSS-REFERENCE TO RELATED APPLICATION

This application claims priority to and benefit of Korean Patent Application No. 10-2011-0102357, filed on Oct. 7, 2011, the contents of which are herein incorporated by reference.

### BACKGROUND OF THE INVENTION

1. Field of the Invention

The present invention is related to display apparatuses and methods for displaying three-dimensional (“3D”) images. The present invention is related to display apparatuses and methods for displaying 3D images with improved quality.

2. Description of the Related Art

Conventionally, liquid crystal display apparatuses are configured to display two-dimensional (“2D”) images. Recently, as the demand for displaying 3D images increases in various applications, such as video games and movies, liquid crystal display apparatuses for displaying 3D images have been developed.

Generally, a stereoscopic image display apparatus displays a 3D image using the binocular parallax between two eyes of a human. For example, since the two eyes of a viewer are spaced apart from each other, images viewed at different angles are inputted to the viewer's brain. The viewer's brain mixes the images so that the viewer may perceive the 3D (or stereoscopic) image.

Stereoscopic image display devices may be categorized into an eyewear-stereoscopic type and an auto-stereoscopic type depending on whether a viewer wears an extra spectacle or not. The eyewear-stereoscopic type may include an anaglyph type and a shutter glass type. In the anaglyph type, viewers wear blue glasses and red glasses to view 3D images. In the shutter glass type, a left image and a right image may be temporally divided to be periodically displayed, and a viewer wears glasses which opens and closes a left eye shutter and a right eye shutter in synchronization with the period of the left and right images.

The auto-stereoscopic type may include a lenticular type and a barrier type. In the lenticular type, a lenticular lens having a plurality of focal points is used. The 2D image is refracted by the lenticular lens at the focal points so that the 3D image is displayed. In the barrier type, a plurality of barriers selectively covering a display panel is used. The barriers selectively block an image on the display panel so that a left image and a right image become different from each other. Thus, 2D images are converted into 3D images by the barriers.

When a 2D image is converted into a 3D image, the resolution of the liquid crystal display apparatus is typically decreased; as a result, the display quality may deteriorate. Additionally, a crosstalk, which means that a left image is shown in a right eye or a right image is shown in a left eye, may tend to occur, and a backlight assembly may be repetitively turned on and off to prevent the crosstalk; as a result, the luminance of the display panel may be decreased.

### BRIEF SUMMARY OF THE INVENTION

One or more embodiments of the present invention are related to a display apparatus for enabling a viewer to perceive a three-dimensional image with desirable quality.

One or more embodiments of the present invention are related to a method for enabling a viewer to perceive a three-dimensional image with desirable quality.

In one or more embodiments, the display apparatus includes a display panel. The display apparatus further includes a display panel driver providing image data to the display panel during a frame, the image data including first image data and second image data, the frame including a first sub-frame and a second sub-frame, the display panel driver providing the first image data to the display panel during the first sub-frame and providing the second image data to the display panel during the second sub-frame. The display apparatus further includes a barrier part that includes a plurality of barriers for adjusting presentation of a two-dimensional image displayed on the display panel to enable the viewer to perceive the three-dimensional image, the plurality of barriers including a first barrier and a second barrier neighboring the first barrier. The display apparatus further includes a barrier driver for controlling the barrier part so that the first barrier permits transmission of first light during the first sub-frame and so that the second barrier permits transmission of second light during the second sub-frame.

In one or more embodiments, the first image data is configured for providing a first plurality of left image portions and a first plurality of right image portions that are alternately disposed with each other, and the second image data is configured for providing a second plurality of left image portions and a second plurality of right image that are alternately disposed with each other.

In one or more embodiments, the first plurality of left image portions is shown to a left eye of the viewer during the first sub-frame, the second plurality of left image portions is shown to the left eye of the viewer during the second sub-frame, the first plurality of right image portions is shown to a right eye of the viewer during the first sub-frame, and the second plurality of right image portions is shown to the right eye of the viewer during the second sub-frame.

In one or more embodiments, the barrier part includes a first barrier substrate, a second barrier substrate facing the first barrier substrate, and a barrier liquid crystal layer disposed between the first barrier substrate and the second barrier substrate.

In one or more embodiments, a width of the unit pixel in a first direction is substantially equal to a width of at least one of the first barrier and the second barrier in the first direction.

In one or more embodiments, the barrier part drives the barrier part in synchronization with a scanning timing of the display panel, and a set of barriers among the plurality of barriers blocks light transmission during a scanning period in the second sub-frame and permits light transmission after the scanning period in the second sub-frame.

In one or more embodiments, the scanning period corresponds to a transient response period of a liquid crystal layer of the display panel.

In one or more embodiments, a scanning direction of the display panel is substantially same as a scanning direction of the barrier part, and the scanning direction of the display panel is substantially perpendicular to an extending direction of the first barrier.

In one or more embodiments, the barrier part includes a first electrode, a plurality of electrodes, and a barrier liquid crystal layer disposed between the first electrode and the plurality of electrodes, and an electrode of the plurality of electrodes extends in a direction substantially perpendicular to the scanning direction of the display panel.

In one or more embodiments, a same voltage is applied to the first electrode during both of the first sub-frame and the second sub-frame.

In one or more embodiments, a scanning direction of the display panel is substantially same as a scanning direction of the barrier part, and the scanning direction of the display panel is substantially same as an extending direction of a column of barriers among the plurality of barriers.

In one or more embodiments, the barrier part includes a first plurality of electrodes, a second plurality of electrodes crossing the first plurality of electrodes, and a barrier liquid crystal layer disposed between the first plurality of electrodes and the second plurality of electrodes, an electrode of the first plurality of electrodes extends in a direction substantially perpendicular to the scanning direction of the display panel, and an electrode of the second plurality of electrodes extends in the scanning direction of the display panel.

In one or more embodiments, a first voltage is applied to odd-numbered electrodes of the second plurality of electrodes, and a second voltage is applied to even-numbered electrodes of the second plurality of electrodes.

In one or more embodiments, the first voltage is inverted with respect to the second voltage.

In one or more embodiments, the display apparatus further includes a viewpoint detecting camera for detecting a viewpoint of the viewer, and the display apparatus further includes a compensating part for compensating a barrier driving signal provided by the barrier driver based on the viewpoint of the viewer.

In one or more embodiments, each barrier of the plurality of barriers corresponds to an area at which an electrode of a first plurality of electrodes overlaps an electrode of a second plurality of electrodes.

In one or more embodiments, the display panel and the barrier part are rotatable for about 90 degree.

One or more embodiments of the present invention are related to a method for enabling a viewer to perceive a three-dimensional image. The method includes providing first image data to a display panel during a first sub-frame and providing second image data to the display panel during a second sub-frame. The method further includes controlling a barrier part for adjusting presentation of a two-dimensional image displayed on the display panel to the viewer, the barrier part including a plurality of barriers, the plurality of barriers including a first barrier and a second barrier neighboring the first barrier. For example, the method includes controlling the first barrier such that the first barrier permits transmission of first light during the first sub-frame, and the method further includes controlling the second barrier such that the second barrier permits transmission of second light during the second sub-frame.

In one or more embodiments, the method further includes driving the barrier part in synchronization with a scanning timing of the display panel, and the method further includes controlling a set of barriers among the plurality of barriers such that the set of barriers blocks light transmission during a scanning period in the second sub-frame and permits light transmission after the scanning period in the second sub-frame.

In one or more embodiments, the scanning period corresponds to a transient response period of a liquid crystal layer of the display panel.

In one or more embodiments, a scanning direction of the display panel is substantially same as a scanning direction of the barrier part, and the scanning direction of the display panel is substantially perpendicular to an extending direction of the first barrier.

In one or more embodiments, the barrier part includes a first electrode, a plurality of electrodes, and a barrier liquid crystal layer disposed between the first electrode and the plurality of electrodes, and an electrode of the plurality of electrodes extends in a direction substantially perpendicular to a scanning direction of the display panel.

In one or more embodiments, a scanning direction of the display panel is substantially same as a scanning direction of the barrier part, and the scanning direction of the display panel is substantially same as an extending direction of a column of barriers among the plurality of barriers.

In one or more embodiments, the barrier part includes a first plurality of electrodes, a second plurality of second electrodes crossing the first plurality of electrodes, and a barrier liquid crystal layer disposed between the first plurality of electrodes and the second plurality of electrodes, an electrode of the first plurality of electrodes extends in a direction substantially perpendicular to the scanning direction of the display panel, and an electrode of the second plurality of electrodes extends in the scanning direction of the display panel.

According embodiments of the invention, a set of barriers of the barrier part has a blocking state during an early scanning period in a sub-frame. As a result, a potential crosstalk, i.e., undesirable mixture of images, may be prevented. Advantageously, three-dimensional images with desirable display quality may be perceived by the viewer. In addition, a light source part may continue to provide light so that desirable luminance of the display panel may be maintained.

### BRIEF DESCRIPTION OF THE DRAWINGS

The above and other features and advantages of the present invention will become more apparent in view of embodiments thereof with reference to the accompanying drawings, in which:

FIG. 1 is a perspective view illustrating elements of a display apparatus according to an embodiment of the present invention;

FIG. 2A is a diagram illustrating images provided to the eyes of an viewer by a display panel and a barrier part illustrated in FIG. 1 in an odd-numbered frame;

FIG. 2B is a diagram illustrating images provided to the eyes of the viewer by the display panel and the barrier part illustrated in FIG. 1 in an even-numbered frame;

FIG. 3 is a diagram illustrating synthesized images provided to the eyes of the viewer by the display panel and the barrier part illustrated in FIG. 1;

FIG. 4 is a plan view illustrating the display panel, a gate driver, and a data driver of the display apparatus that has elements illustrated in FIG. 1;

FIG. 5 is a plan view illustrating details of the barrier part illustrated in FIG. 1;

FIG. 6 is a diagram illustrating scanning driving method for driving the display panel and the barrier part illustrated in FIG. 1;

FIG. 7 is a waveform diagram illustrating barrier driving signals outputted from the barrier driver illustrated in FIG. 1;

FIG. 8 is a perspective view illustrating elements of a display apparatus according to an embodiment of the present invention;

FIG. 9 is a plan view illustrating a display panel, a gate driver, and a data driver according to an embodiment of the present invention;

FIG. 10 is a plan view illustrating a barrier part of a display apparatus that includes the display panel illustrated in FIG. 9;

FIG. 11 is a diagram illustrating scanning driving of the display panel illustrated in FIG. 9 and the barrier part illustrated in FIG. 10;

FIG. 12 is a waveform diagram illustrating barrier driving signals outputted from a barrier driver according to an embodiment of the present invention; and

FIG. 13 is a graph illustrating light transmittance according to a voltage of the barrier part illustrated in FIG. 10.

### DETAILED DESCRIPTION OF THE INVENTION

Hereinafter, embodiments of the present invention will be described in further detail with reference to the accompanying drawings.

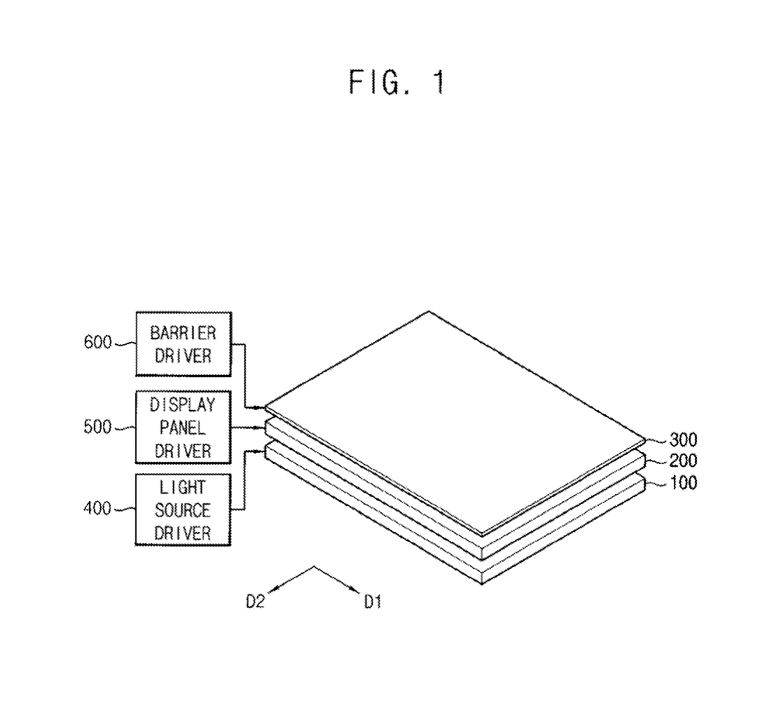

FIG. 1 is a perspective view illustrating elements of a display apparatus according to an embodiment of the present invention.

Referring to FIG. 1, the display apparatus includes a light source part 100, a display panel 200, a barrier part 300, a light source driver 400, a display panel driver 500, and a barrier driver 600, each including one or more hardware electrical circuits.

The light source part 100 provides light to the display panel 200. The light source part 100 includes a light source for generating the light. For example, the light source may include one or more of a cold cathode fluorescent lamp (“CCFL”), an external electrode fluorescent lamp (“EEFL”), a flat fluorescent lamp (“FFL”), and a light emitting diode (“LED”). The light source part 100 may be a backlight assembly.

The light source part 100 may be a direct type light source part which is disposed under the display panel 200 to provide light to the display panel 200. Alternatively or additionally, the light source part 100 may include an edge type light source part which is disposed corresponding to an edge of the display panel 200 to provide light to the display panel 200. If the light source part 100 is an edge type light source part, the light source part 100 may further include a light guide plate (not shown).

The display panel 200 is configured to display images. The display panel 200 is disposed on the light source part 100. The display panel includes a first panel substrate (not shown), a second panel substrate (not shown) facing the first panel substrate, and a liquid crystal layer (not shown) disposed between the first and second panel substrates.

The barrier part 300 is disposed on the display panel 200. The barrier part 300 includes a plurality of barriers for selectively covering at least a portion of the display panel 200 and/or at least a portion of the light source part 100. The barriers convert a 2D image into a 3D image.

The barrier part 300 includes a first barrier substrate (not shown), a second barrier substrate (not shown) facing the first barrier substrate, and a barrier liquid crystal layer (not shown) disposed between the first and second barrier substrates.

A first electrode may be formed on the first barrier substrate. A second electrode may be formed on the second barrier substrate. According to voltages applied to the first and second electrodes, the barriers of the barrier part 300 have a transmitting state or a blocking state.

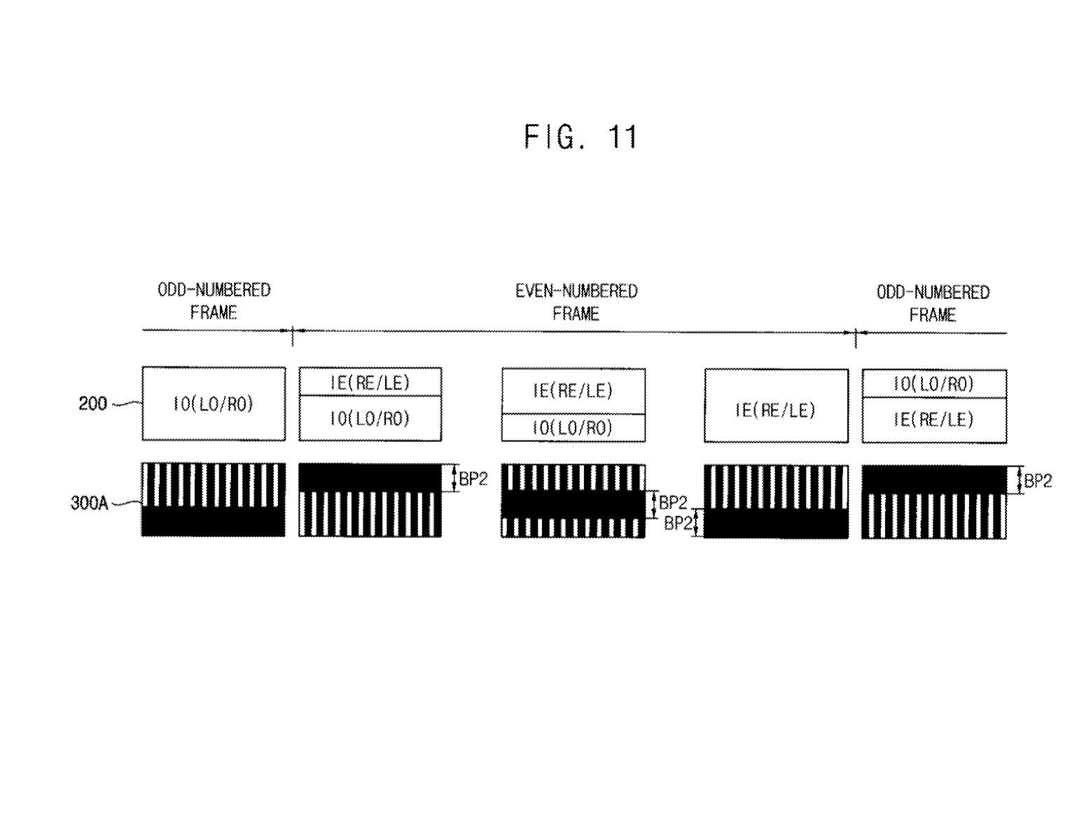

A barrier may have an elongated shape extending in a certain direction. The barrier may extend in a second direction D2, which is parallel to the shorter side of the barrier part 300. The barriers of the barrier part 300 may be disposed in a stripe pattern (to be further discussed with reference to FIG. 5). The barriers of the barrier part 300 may be disposed in a matrix pattern (to be further discussed with reference to FIG. 10).

Although the barrier part 300 is disposed on the display panel 200 in the present embodiment, the present invention is not limited thereto. The barrier part 300 may be disposed under the display panel 200, between the display panel 200 and the light source part 100.

The light source driver 400 is electrically connected to the light source part 100.

The light source driver 400 generates a light source driving voltage for driving the light source in the light source part 100. The light source driver 400 receives a light source control signal from an external device. The light source driver 400 generates the light source driving voltage based on the light source control signal. The light source driver 400 outputs the light source driving voltage to the light source part 100. The light source driver 400 may include a DC/DC (direct-current/direct-current) converter.

The light source driver 400 may be disposed under the light source part 100. The light source driver 400 may be disposed outside a receiving container (not shown) and facing a bottom surface of the receiving container.

The display panel driver 500 is electrically connected to the display panel 200. The display panel driver 500 generates a panel driving signal for driving the display panel 200. The display panel driver 500 drives the display panel 200 by dividing a single frame into N sub-frames. Here, N is a natural number. In one or more embodiments, N is an even number, such as 2.

For example, the display panel driver 500 divides a single frame into a first sub-frame and a second sub-frame. The first sub-frame may be an odd-numbered sub-frame, hereinafter referred to as an “odd-numbered frame,” that is assigned an odd number. The second sub-frame may be an even-numbered sub-frame, hereinafter referred to as an “even-numbered frame,” that is assigned an even number. The display panel driver 500 provides first image data to the display panel 200 during the first sub-frame. The display panel driver 500 provides second image data to the display panel 200 during the second sub-frame.

The display panel driver 500 includes a gate driver and a data driver.

The gate driver generates gate signals for driving the gate lines of the display panel 200. The gate driver outputs the gate signals to the gate lines. The gate driver sequentially outputs the gate signals to the gate lines so that the display panel 200 is driven according to a scanning driving method.

The data driver generates data voltages for driving the data lines of the display panel 200. The data driver outputs the data voltages to the data lines of the display panel 200.

The barrier driver 600 is electrically connected to the barrier part 300. The barrier driver 600 generates a barrier driving signal for driving the barrier part 300. In a manner consistent to the operation of the display panel driver 500, the barrier driver 600 drives the barrier part 300 by dividing a single frame into N sub-frames.

For example, the barrier driver 600 divides a single frame into a first sub-frame and a second sub-frame. The barrier driver 600 controls a first plurality of barriers and a second plurality of barriers that are alternately disposed so that the first plurality of barriers has transmitting states (i.e., does not block image/light transmission) during the first sub-frame and that the second plurality of barriers has transmitting states during the second sub-frame. The first plurality of barriers and the second plurality of barriers are alternately disposed such that, for example, a first barrier of the first plurality of barriers neighbors a first barrier of the second plurality of barriers, which neighbors a second barrier of the first plurality of barriers, which neighbors a second barrier of the second plurality of barriers, which neighbors a third barrier of the first plurality of barriers, and so on.

The barrier driver 600 sequentially outputs the barrier driving signal so that the barrier part 300 is driven according to a scanning driving method. The barrier driver 600 drives the barrier part 300 in synchronization with a scanning timing of the display panel 200. A scanning direction of the barrier part 300 is the same as and/or is consistent with a scanning direction of the display panel 200.

In an embodiment, the display panel 200 and the barrier part 300 may be rotatable for, as an example, about 90 degree. When the display panel 200 and the barrier part 300 are rotated, the display panel driver 500 and the barrier driver 600 may also be rotated.

In an embodiment, the display panel driver 500 is rotatable, the gate driver may be disposed adjacent to (and substantially parallel to) a side portion of the display panel 200 in a first mode, and the gate driver may be disposed adjacent to (and substantially parallel to) an upper portion of the display panel 200 in a second mode.

In an embodiment, the display panel driver 500 is rotatable, a scanning direction of the display panel 200 may be the second direction D2 in the first mode, and a scanning direction of the display panel 200 may be a first direction D1 in the second mode. The first mode may be a landscape mode. The second mode may be a portrait mode.

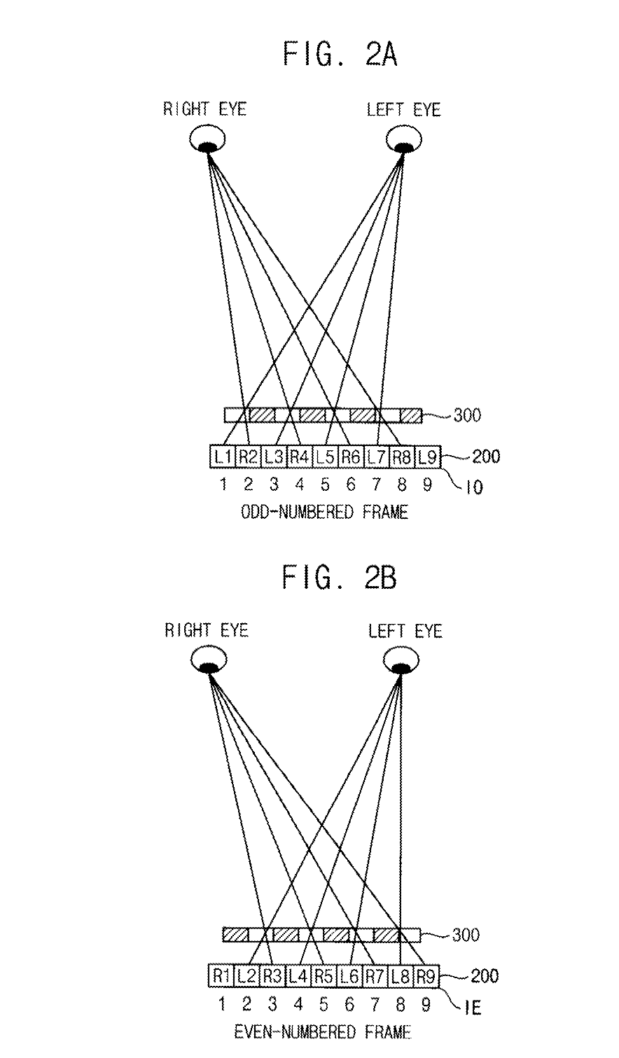

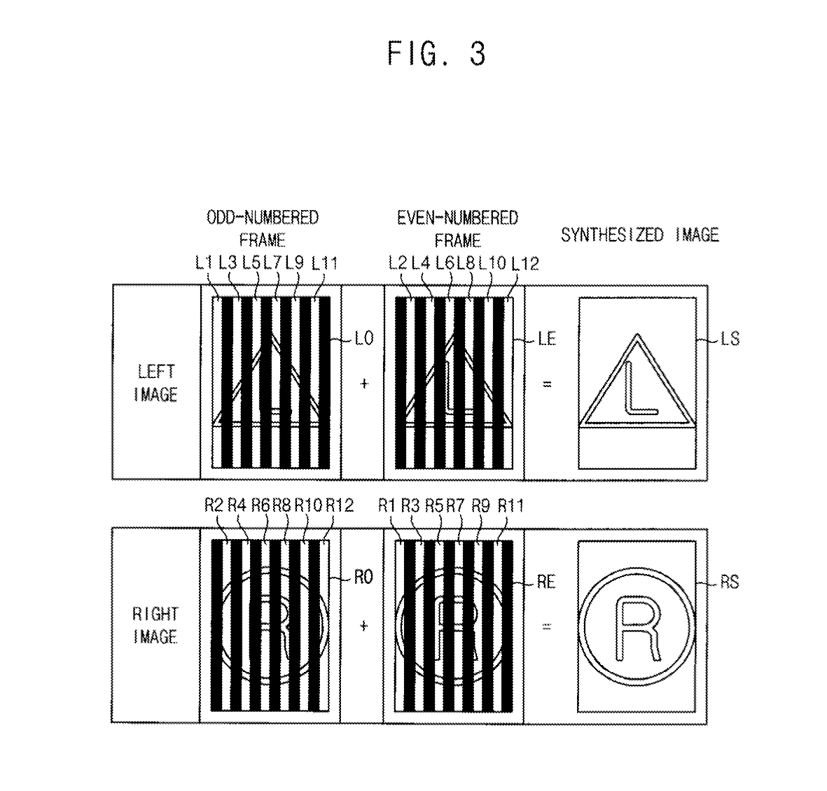

FIG. 2A is a diagram illustrating images provided to the eyes of an viewer by the display panel 200 and the barrier part 300 illustrated in FIG. 1 in the odd-numbered frame. FIG. 2B is a diagram illustrating images provided to the eyes of the viewer by the display panel 200 and the barrier part 300 illustrated in FIG. 1 in the even-numbered frame. FIG. 3 is a diagram illustrating synthesized images provided to the eyes of the viewer by the display panel 200 and the barrier part 300 illustrated in FIG. 1.

Hereinafter, a method of displaying a 3D image using the display apparatus is explained in detail referring to FIGS. 1 to 3. According to the method, a single frame is divided into an odd-numbered frame and an even-numbered frame.

Referring to FIG. 2A, a first image IO includes a first plurality of left image portions L1, L3, L5, etc. and a first plurality of right image portions R2, R4, R6, etc. during the odd-numbered frame. The first plurality of left image portions L1, L3, L5, etc. and the first plurality of right image portions R2, R4, R6, etc. are alternately disposed with each other on the display panel 200. For example, R2 is displayed between L1 and L3, L3 is displayed between R2 and R4, R4 is displayed between L3 and L5, and so on. Each of the first plurality of left image portions and the first plurality of right image portions is sequentially disposed on the display panel 200. For example, L3 is displayed between L1 and L5, L5 is displayed between L3 and L7, and so on; R4 is displayed between R2 and R6, R6 is displayed between R4 and R8, and so on.

During the odd-numbered frame, the first plurality of barriers (illustrated by the plurality of white portions of the barrier part 300 in FIG. 2A) has a transmitting state (i.e., permits image/light transmission), and the second plurality of barriers (illustrated by the plurality of hatched portions of the barrier part 300 in FIG. 2A), which is alternately disposed with respect to the first plurality of barriers, has a blocking state (i.e., blocks image/light transmission). The first plurality of barriers and the second plurality of barriers may be alternately disposed with each other along the first direction D1. In addition, the barriers may extend in the second direction D2.

During the odd-numbered frame, the first plurality of left image portions L1, L3, L5, etc., which corresponds to odd-numbered viewed points 1, 3, 5, etc., is shown to the left eye of the viewer through the first plurality of barriers, which has the transmitting state. During the odd-numbered frame, the first plurality of right image portions R2, R4, R6, etc., which corresponds to even-numbered viewed points 2, 4, 6, etc., is shown to the right eye of the viewer through the first plurality of barriers, which has the transmitting state. The viewed points correspond to portions of the display panel 200 visible to and/or viewed by the viewer.

Referring to FIG. 2B, a second image IE includes a second plurality of right image portions R1, R3, R5, etc. and a second plurality of left image portions L2, L4, L6, etc. during the even-numbered frame. The second plurality of right image portions R1, R3, R5, etc. and the second plurality of left image portions L2, L4, L6, etc. are alternately disposed with each other on the display panel 200. Each of the second plurality of right image portions and the second plurality of left image portions is sequentially disposed on the display panel 200.

During the even-numbered frame, the first plurality of barriers (illustrated by the plurality of hatched portions of the barrier part 300 in FIG. 2B) has a blocking state (i.e., blocks image/light transmission), and the second plurality of barriers (illustrated by the plurality of white portions of the barrier part 300 in FIG. 2B), which is alternately disposed with respect to the first plurality of barriers, has a transmitting state (i.e., permits image/light transmission). The first plurality of barriers and the second plurality of barriers may be alternately disposed with each other along the first direction D1. In addition, the barriers may extend in the second direction D2.

During the even-numbered frame, the second plurality of left image portions L2, L4, L6, etc., which corresponds to even-numbered viewed points 2, 4, 6, etc., is shown to the left eye of the viewer through the second plurality of barriers, which has the transmitting state.

During the even-numbered frame, the second plurality of right image potions R1, R3, R5, etc., which corresponds to odd-numbered viewed points 1, 3, 5, etc., is shown to the right eye of the viewer through the second plurality of barriers, which has the transmitting state.

Referring to FIG. 3, during the odd-numbered frame, the first left image LO, which corresponds to the odd-numbered viewed points 1, 3, 5, etc. (illustrated in FIGS. 2A and 2B), is shown to the left eye of the viewer. During the even-numbered frame, the second left image LE, which corresponds to the even-numbered viewpoint 2, 4, 6, etc. (illustrated in FIGS. 2A and 2B), is shown to the right eye of the viewer. The odd-numbered frame and the even-numbered frame are repetitively alternated with each other in a relatively high speed so that the brain of the viewer may synthesize the first left image LO and the second left image LE for the viewer to perceive a left synthesized image LS.

During the odd-numbered frame, the first right image RO, which corresponds to the even-numbered viewpoint 2, 4, 6, etc., is shown to the right eye of the viewer. During the even-numbered frame, the second right image RE, which corresponds to the odd-numbered viewed points 1, 3, 5, etc., is shown to the right eye of the viewer. The odd-numbered frame and the even-numbered frame are repetitively alternated with each other in a high speed so that the brain of the viewer may synthesize the first right image RO and the second right image RE for the viewer to perceive a right synthesized image RS.

The brain of the viewer may mix the left synthesized image LS and the right synthesized image RS so that the viewer may recognize the 3D image.

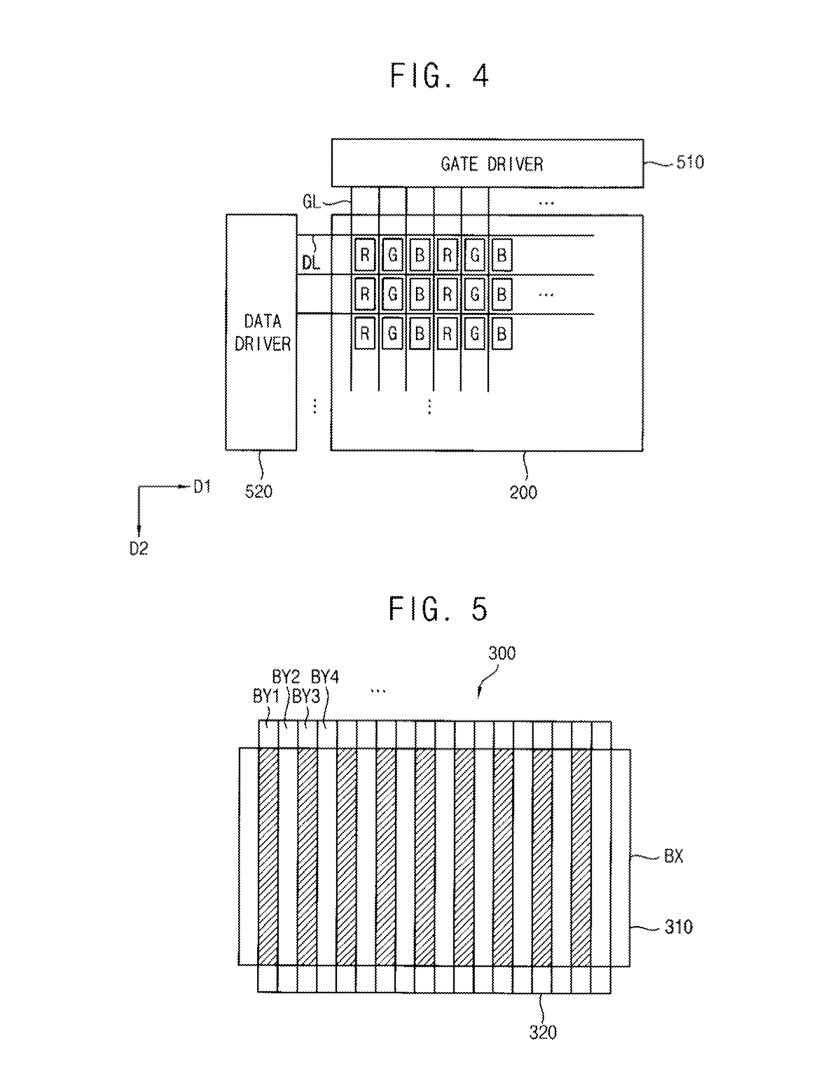

FIG. 4 is a plan view illustrating the display panel, the gate driver, and the data driver of the display apparatus that has elements illustrated in FIG. 1.

Referring to FIGS. 1 and 4, the display panel 200 has a rectangular shape. For example, the display panel 200 has a longer side extending in the first direction D1 and a shorter side extending in the second direction D2 (which may be substantially perpendicular to the first direction D1).

The display panel 200 includes a plurality of gate lines GL, a plurality of data lines DL crossing the gate lines GL, and a plurality of unit pixels (e.g., R, G and B pixels) electrically connected to the gate lines GL and the data lines DL.

The gate lines GL extend in the second direction D2. The gate lines GL are disposed along the first direction D1. The data lines DL extend in the first direction D1. The data lines DL are disposed along the second direction D2.

The unit pixels may include at least one of a red pixel R, a green pixel G, and a blue pixel B. Alternatively or additionally, the unit pixels may include at least one of a white pixel, a yellow pixel, a magenta pixel, and a cyan pixel.

A unit pixel of the unit pixels may have a rectangular shape. For example, the unit pixel may have a shorter side extending in the first direction D1 and a longer side extending in the second direction D2. Alternatively, the unit pixel may have a shorter side extending in the second direction D2 and a longer side extending in the first direction D1.

The unit pixels R, G, and B may be disposed in a matrix pattern. For example, a first pixel column includes red pixels R, a second pixel column includes green pixels G, and a third pixel column includes blue pixels B.

Alternatively, each of the first to third pixel columns may include red, green and blue pixels R, G and B alternately disposed with one another.

The display driver 500 includes the gate driver 510 and the data driver 520.

The gate driver 510 is disposed adjacent to an upper portion (e.g., a longer side) of the display panel 200 and may have a longer side that is substantially parallel to the longer sides of display panel 200. The data driver 520 is disposed adjacent to a side portion (e.g., a shorter side) of the display panel 200 and may have a longer side that is substantially parallel to the shorter sides of display panel 200. The gate driver 510 is electrically connected to the gate lines GL and may provide gate signals to the gate lines GL in the second direction D2. The data driver 520 is electrically connected to the data lines DL and may provide data voltages to the data lines DL in the first direction D1.

The gate driver 510 receives a first control signal from a timing controller (not shown). The gate driver 510 generates the gate signals (and provides the gate signals to the gate lines GL of the display panel 200) in response to the first control signal. The gate driver 510 sequentially outputs the gate signals to the gate lines GL according to a scanning direction. In one or more embodiments, the scanning direction of the display panel 200 is the same as and/or consistent with the first direction Dl.

The gate driver 510 may include a gate printed circuit board (“PCB”, not shown) and a gate driving chip (not shown). The gate driving chip may be disposed on a tape carrier package (“TCP”) connecting the gate PCB to the first panel substrate of the display panel 200.

Alternatively or additionally, the gate driver 510 may include one or more components that are directly mounted on the display panel 200. In one or more embodiments, the gate driver 510 may be integrated on the display panel 200.

The data driver 520 receives a data signal and a second control signal from the timing controller. The data driver 520 converts the data signal into data voltages having analogue types in response to the second control signal. The data driver sequentially outputs the data voltages to the data lines DL of the display panel 200.

The data driver 520 may include a data PCB (not shown) and a data driving chip (not shown). The data driving chip may be disposed on a TCP connecting the data PCB to the first panel substrate of the display panel 200.

Alternatively or additionally, the data driver 520 may include one or more components that are directly mounted on the display panel 200. In one or more embodiments, the data driver 520 may be integrated on the display panel 200.

FIG. 5 is a plan view illustrating the barrier part of FIG. 1.

Referring to FIGS. 1, 4 and 5, the barrier part 300 includes the first barrier substrate 310, the second barrier substrate 320 facing the first barrier substrate 310, and the barrier liquid crystal layer (not shown) disposed between the first and second barrier substrates 310 and 320.

The first barrier substrate 310 includes a single electrode BX. The second barrier substrate 320 includes a plurality of electrodes BY1, BY2, BY3, etc. Each barrier of the barriers is defined as an area at which the single electrode BX overlaps one of the electrodes BY1, BY2, BY3, etc. The barriers are disposed in a stripe pattern.

An extending direction of the barrier may be substantially perpendicular to the scanning direction of the display panel 200. For example, the extending direction of the barrier may be the second direction D2 (illustrated in FIG. 4).

A width of each of the plurality of electrodes BY1, BY2, BY3, etc. in the first direction D1 is substantially equal to a width of the unit pixel in the first direction D1. Thus, a width of a barrier in the first direction D1 is substantially equal to the width of the unit pixel in the first direction D1. Alternatively, the width of the barrier in the first direction D1 may correspond to a combined width of a plurality of unit pixels in the first direction D1.

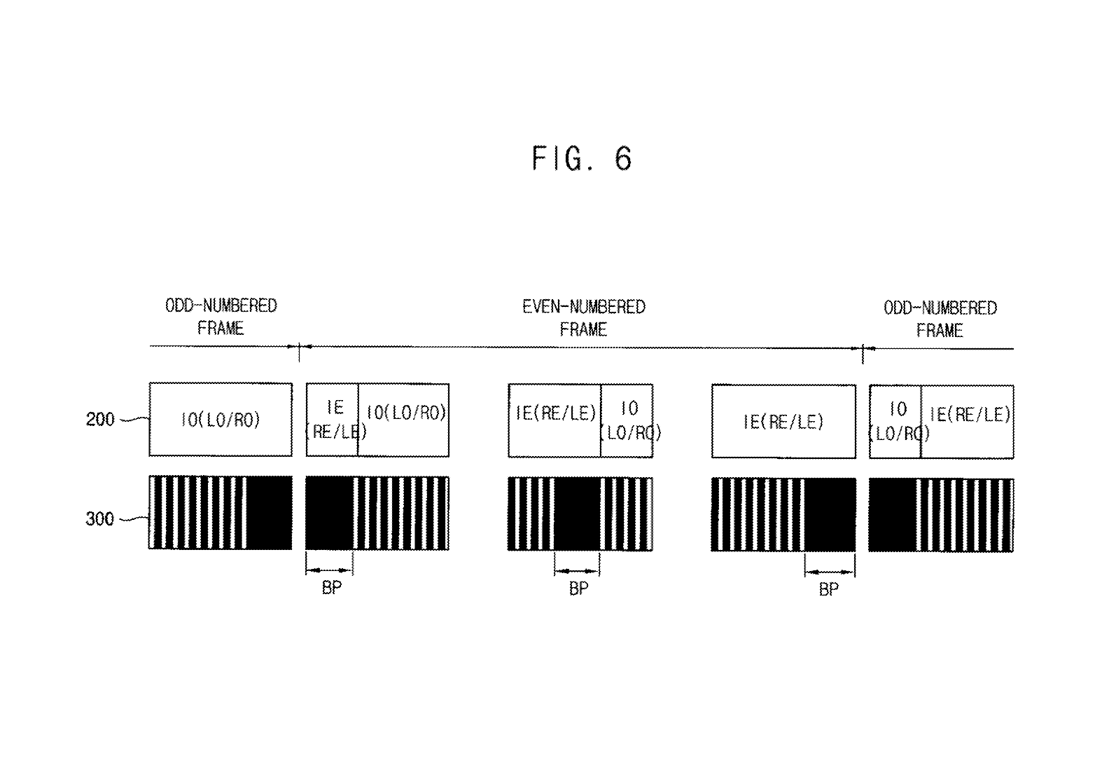

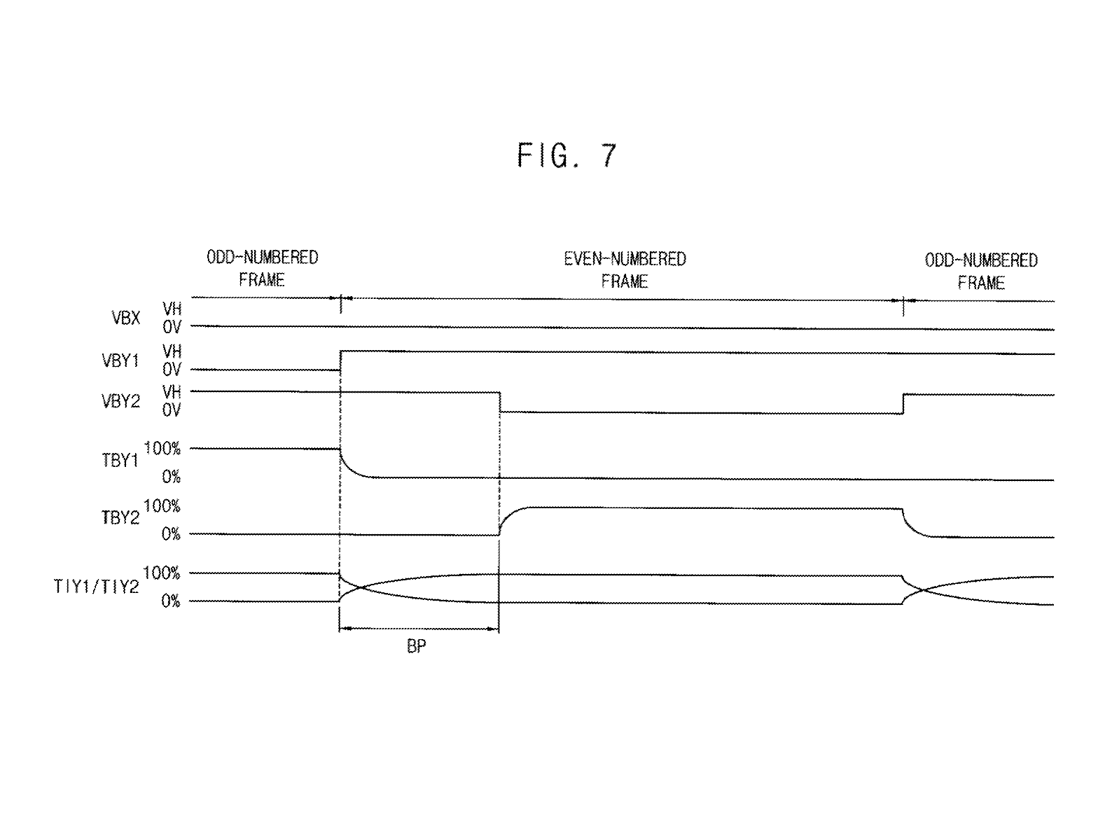

FIG. 6 is a diagram illustrating a scanning driving method for driving the display panel 200 and the barrier part 300 illustrated in FIG. 1. FIG. 7 is a waveform diagram illustrating barrier driving signals outputted from the barrier driver 600 illustrated in FIG. 1.

Referring to FIG. 6, the scanning direction of the display panel 200 is the first direction D1 (illustrated in FIG. 4) in an embodiment. Accordingly, the display panel 200 is scanned in a horizontal direction from left to right.

Referring to an ending period of the odd-numbered frame, the first image I0 is displayed on the display panel 200. The first image data IO includes the first left image LO and the first right image RO.

Referring to a beginning period of the even-numbered frame, the second image IE is displayed on a left portion of the display panel 200 that corresponds to a beginning portion of the scanning direction. The second image data IE includes the second right image RE and the second left image LE. At least a portion of the first image IO is still displayed on a right portion of the display panel 200 that corresponds to an ending portion of the scanning direction.

In the unit pixels on the left portion of the display panel 200, the image data (i.e., data voltages) received by the unit pixels is changed from data associated with the first image IO to data associated with the second image IE. When a data voltage is charged or discharged in the unit pixel, accurate data may not be displayed due to a transient response of the liquid crystal layer of the display panel 200. For example, the first image IO and the second image IE may be mixed in the unit pixels on the left portion of the display panel 200 so that a crosstalk, which means that a left image is shown in the right eye and/or a right image is shown in the left eye, may occur if display of the images is not properly controlled.

In one or more embodiments, the barrier driver 600 controls a first set of barriers of the barrier part 300, which corresponds to the left portion of the display panel 200, to have the blocking state during an early scanning period BP of the unit pixels on the left portion of the display panel 200 so that the crosstalk may be prevented. The early scanning period BP during which the first set of barriers of the barrier part 300 has the blocking state corresponds the transient response period of the liquid crystal layer of the display panel 200.

Referring to a middle period of the even-numbered frame, the second image IE is displayed on a left portion and a central portion of the display panel 200 that correspond to the beginning portion and a middle portion, respectively, of the scanning direction. The first image IO is still displayed on a right portion of the display panel 200 that corresponds to the ending portion of the scanning direction.

In the unit pixels on the central portion of the display panel 200, the image data received by the unit pixels is changed from data associated with the first image IO to data associated with the second image IE. The first image IO and the second image IE may be mixed in the unit pixels on the central portion of the display panel 200 so that a crosstalk may occur if display of the images is not properly controlled.

In one or more embodiments, the barrier driver 600 controls a second set of barriers of the barrier part 300, which corresponds to the central portion of the display panel 200, to have the blocking state during an early scanning period BP of the unit pixels on the central portion of the display panel 200 so that the crosstalk may be prevented. The early scanning period BP during which the second set of barriers of the barrier part 300 has the blocking state corresponds the transient response period of the liquid crystal layer of the display panel 200.

Referring to an ending period of the even-numbered frame, the second image IE is displayed on substantially the entire area of the display panel 200.

In the unit pixels on the right portion of the display panel 200, which corresponds to the ending portion of the scanning direction, image data received by the unit pixels is changed from data associated with the first image IO to data associated with the second image IE. The first image IO and the second image IE may be mixed in the unit pixels on the right portion of the display panel 200 so that a crosstalk may occur if display of the images is not properly controlled.

In one or more embodiments, the barrier driver 600 controls a third set of barriers of the barrier part 300, which corresponds to the right portion of the display panel 200, to have the blocking state during an early scanning period BP of the unit pixels on the right portion of the display panel 200 so that the crosstalk may be prevented. The early scanning period BP during which the third set of barriers of the barrier part 300 has the blocking state corresponds the transient response period of the liquid crystal layer of the display panel 200.

FIG. 7 illustrates voltages applied to the electrodes BX, BY1, and BY2 (illustrated in FIG. 5) to operate the scanning driving method discussed with reference to FIG. 6. FIG. 7 further illustrates transmittances of the barriers associated with the electrodes BY1 and BY2 according to the voltages applied to the electrodes BX, BY1, and BY2. FIG. 7 further illustrates transmittances of the unit pixels corresponding to the barriers.

Referring to FIG. 7, VBX represents a voltage applied to the electrode BX. VBY1 and VBY2 represent voltages applied to the electrodes BY1 and BY2, respectively.

The same voltage may be applied to the first electrode BX during both of the odd-numbered frame and the even-numbered frame. A voltage of about 0V may be applied to the first electrode BX during the odd-numbered frame and the even-numbered frame. Voltages applied to the second electrodes BY1 and BY2 are different from each other. In addition, the voltages applied to the second electrodes BY1 and BY2 may be changed according to the sub-frames.

TBY1 represents a transmittance of a first barrier which is defined by the electrode BX and the electrode BY1. The transmittance of the first barrier TBY1 is adjusted by a difference between VBX and VBY1. TBY2 represents a transmittance of a second barrier which is defined by the electrode BX and the electrode BY2. The transmittance of the second barrier TBY2 is adjusted by a difference between VBX and VBY2.

TIY1 and TIY2 represent transmittances of the unit pixels corresponding to the first barrier and the second barrier.

When the odd-numbered frame is changed to the even-numbered frame, a crosstalk may occur at the unit pixels corresponding to the first barrier and the second barrier due to the transient response of the liquid crystal layer.

The first barrier has the blocking state when the unit pixels begin to be scanned. In addition, the second barrier maintains the blocking state during the early scanning period BP. As can be appreciated from the discussion with reference to FIG. 6, the potential crosstalk during the early scanning period BP may be prevented.

According to the one or more embodiments, the barrier part 300 is driven by the scanning driving method, and a selected set of the barriers has the blocking state during the early scanning period BP, so that the potential crosstalk may be prevented. In addition, the light source part 100 is not required to be repetitively turned on and off to prevent the crosstalk, so that a luminance of the display panel may be maintained. Advantageously, desirable display quality of the 3D image may be provided.

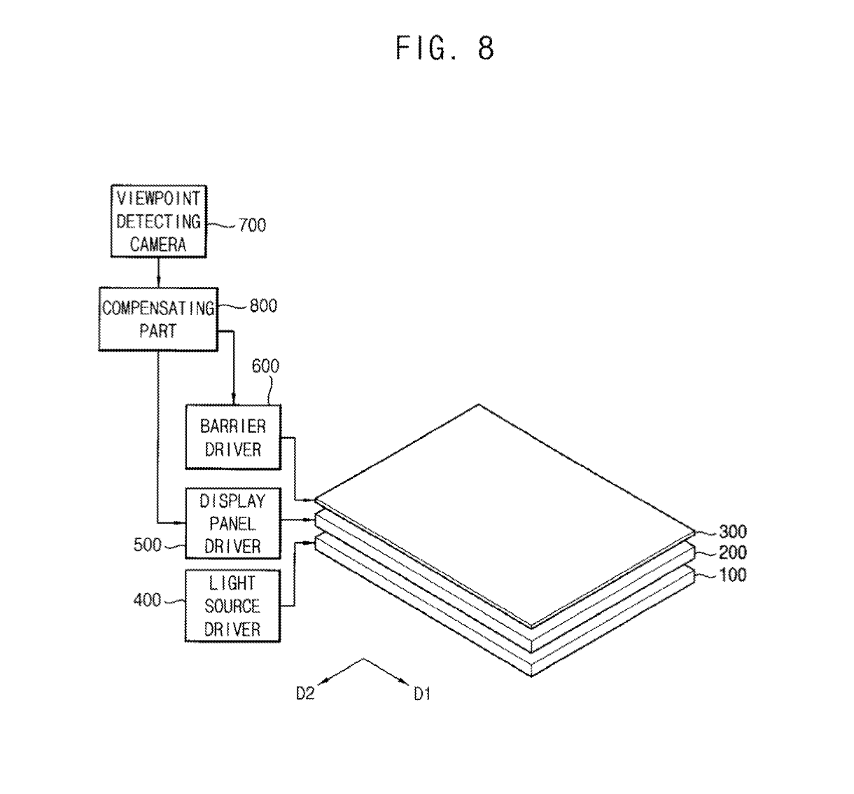

FIG. 8 is a perspective view illustrating elements of a display apparatus according to an embodiment of the present invention.

Elements of a display apparatus illustrated in FIG. 8 may be substantially the same as elements of a display apparatus explained with reference to FIGS. 1 to 7 except a viewpoint sensing camera and a compensating part. Thus, the same reference numerals will be used to refer to the same or like parts as those described with reference to FIGS. 1 to 7, and any repetitive explanation concerning the above elements may be omitted.

Referring to FIG. 8, the display apparatus includes a light source part 100, a display panel 200, a barrier part 300, a light source driver 400, a display panel driver 500, a barrier driver 600, a viewpoint sensing camera 700, and a compensating part 800.

The light source part 100 provides a light to the display panel 200. The light source part 100 includes a light source generating a light.

The display panel 200 displays an image. The display panel 200 is disposed on the light source part 100.

The barrier part 300 is disposed on the display panel 200. The barrier part 300 includes a plurality of barriers selectively covering at least one of the display panel 200 and the light source part 100. The barriers convert a 2D image into a 3D image. A width of the barrier in a first direction D1 may be substantially equal to a width of a unit pixel of the display panel 200 in the first direction Dl.

The light source driver 400 is connected to the light source part 100. The light source driver 400 generates a light source driving voltage for driving the light source.

The display panel driver 500 is connected to the display panel 200. The display panel driver 500 generates a panel driving signal for driving the display panel 200. The display panel driver 500 drives the display panel 200 by dividing a single frame into N sub-frames. Here, N is a natural number.

The barrier driver 600 is connected to the barrier part 300. The barrier driver 600 generates a barrier driving signal for driving the barrier part 300. The barrier driver 600 drives the barrier part 300 by dividing a single frame into N sub-frames.

The viewpoint detecting camera 700 senses at least a viewpoint of a viewer, for determining the viewed points discussed with reference to FIGS. 2A and 2B. The viewpoint detecting camera 700 outputs the detected viewpoint(s) to the compensating part 800. In one or more embodiments, the viewpoint detecting camera 700 may detect at least a position of one or both pupils of the eyes the viewer (illustrated in FIGS. 2A and 2B) from image information of the viewer's face. In one or more embodiments, the viewpoint detecting camera 700 may determine a position of the viewer and at least a direction at which the viewer looks. The viewpoint detecting camera 700 may include a CMOS camera.

The compensating part 800 compensates the barrier driving signal using the detected viewpoint. The compensating part 800 may compensate the panel driving signal using the detected viewpoint.

The barrier of the barrier part 300 may include a plurality of sub-barriers to compensate the 3D image according to the viewpoint. A width of the sub-barrier in the first direction D1 may be smaller than a width of the unit pixel of the display panel 200 in the first direction D1. For example, a single barrier may include twelve sub-barriers.

In one or more embodiments, the barrier driving signal is compensated using the detected viewpoint of the viewer so that a potential crosstalk may be prevented. Thus, 3D images with desirable display quality may be improved.

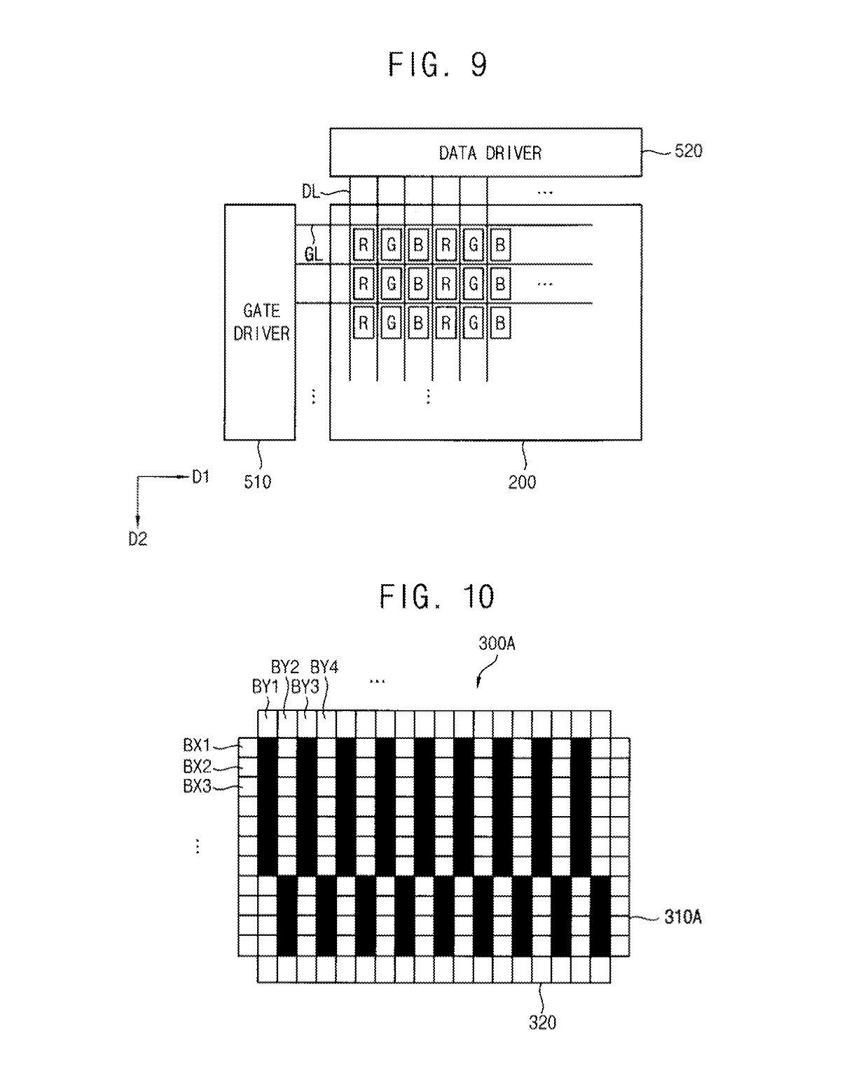

FIG. 9 is a plan view illustrating a display panel, a gate driver, and a data driver according to an embodiment of the present invention.

Elements illustrated in FIG. 9 may be substantially the same as elements explained with reference to one or more of FIGS. 1 to 8 except for a scanning direction of the display panel 200 and a structure of a barrier part 300A (illustrated in FIG. 10) in place of the previously discussed barrier part 300. Thus, the same reference numerals may be used to refer to the same or like parts as those described with reference to FIGS. 1 to 7, and any repetitive explanation concerning the above elements may be omitted.

Referring to FIGS. 1, 9, and 10, the display apparatus includes a light source part 100, a display panel 200, a barrier part 300A in place of the previously discussed barrier part 300, a light source driver 400, a display panel driver 500 and a barrier driver 600, each including one or more hardware electrical circuits.

The light source part 100 provides light to the display panel 200. The light source part 100 includes a light source for generating the light.

The display panel 200 is configured to display images. The display panel 200 is disposed on the light source part 100.

The barrier part 300A is disposed on the display panel 200. The barrier part 300A includes a plurality of barriers for selectively covering at least a portion of the display panel 200 and/or at least a portion of the light source part 100. The barriers convert a 2D image into a 3D image. A width of a barrier among the barriers in a first direction D1 may be substantially equal to a width of a unit pixel of the display panel 200 in the first direction D1.

The light source driver 400 is connected to the light source part 100. The light source driver 400 generates a light source driving voltage for driving the light source in the light source part 100.

The display panel driver 500 is connected to the display panel 200. The display panel driver 500 generates a panel driving signal for driving the display panel 200. The display panel driver 500 drives the display panel 200 by dividing a single frame into N sub-frames. Here, N is a natural number. In one or more embodiments, N is an even number, such as 2.

The barrier driver 600 is connected to the barrier part 300A. The barrier driver 600 generates a barrier driving signal for driving the barrier part 300A. In a manner consistent to the operation of the display panel driver 500, the barrier driver 600 drives the barrier part 300A by dividing a single frame into N sub-frames.

The display panel 200 has a rectangular shape. For example, the display panel 200 has a longer side extending in the first direction D1 and a shorter side extending in a second direction D2 (which may be substantially perpendicular to the first direction D1).

The display panel 200 includes a plurality of gate lines GL, a plurality of data lines DL crossing the gate lines GL and a plurality of unit pixels (e.g., R, G and B pixels) connected to the gate lines GL and the data lines DL.

The gate lines GL extend in the first direction D1. The gate lines GL are disposed along the second direction D2. The data lines DL extend in the second direction D2. The data lines DL are disposed along the first direction D1.

A unit pixel of the unit pixels may have a rectangular shape. For example, the unit pixel may have a shorter side extending in the first direction D1 and a longer side in extending the second direction D2. Alternatively, the unit pixel may have a shorter side extending in the second direction D2 and a longer side extending in the first direction D1.

The display driver 500 includes the gate driver 510 and the data driver 520.

The gate driver 510 is disposed adjacent to a side portion (e.g., a shorter side) of the display panel 200 and may have a longer side that is substantially parallel to the shorter sides of display panel 200. The data driver 520 is disposed adjacent to an upper portion (e.g., a longer side) of the display panel 200 and may have a longer side that is substantially parallel to the longer sides of display panel 200. The gate driver 510 is electrically connected to the gate lines GL and may provide gate signals to the gate lines GL in the first direction D1. The data driver 520 is electrically connected to the data lines DL and may provide data voltages to the data lines DL in the second direction D2.

The gate driver 510 receives a first control signal from a timing controller (not shown). The gate driver 510 generates the gate signals (and provides the gate signals to the gate lines GL of the display panel 200) in response to the first control signal. The gate driver 510 sequentially outputs the gate signals to the gate lines GL according to a scanning direction. In one or more embodiments, the scanning direction of the display panel 200 is defined as the second direction D2.

The data driver 520 receives a data signal and a second control signal from the timing controller. The data driver 520 converts the data signal into data voltages having analogue types in response to the second control signal. The data driver sequentially outputs the data voltages to the data lines DL of the display panel 200.

FIG. 10 is a plan view illustrating a barrier part of a display apparatus that includes the display panel illustrated in FIG. 9.

Referring to FIGS. 1, 8, 9 and 10, the barrier part 300A (in place of the barrier part 300) includes a first barrier substrate 310A, a second barrier substrate 320 facing the first barrier substrate 310A, and a barrier liquid crystal layer (not shown) disposed between the first and second barrier substrates 310A and 320.

The first barrier substrate 310A includes a first plurality of electrodes BX1, BX2, BX3, etc. The second barrier substrate 320 includes a second plurality of electrodes BY1, BY2, BY3, etc. Each barrier of the barriers is defined as an area at which a pixel BXi (wherein i is a natural number) of the first plurality of electrodes overlaps a pixel BYj (wherein j is a natural number) of the second plurality electrodes. The barriers are disposed in a matrix pattern. The barrier part 300A may be driven by a passive matrix type in which each barrier is activated by the pixel BXi of the first plurality of electrodes and the pixel BYj of the second plurality of electrodes.

An extending direction of a column of the barriers may be substantially parallel to and/or consistent with the scanning direction of the display panel 200. For example, the extending direction of the barrier may be the second direction D2 (illustrated in FIG. 9).

A width of each of the second plurality of electrodes BY1, BY2, BY3, etc. in the first direction D1 is substantially equal to a width of the unit pixel in the first direction D1. Thus, a width of a barrier in the first direction D1 is substantially equal to the width of the unit pixel in the first direction D1. Alternatively, the width of the barrier in the first direction D1 may correspond to a combined width of a plurality of unit pixels in the first direction D1.

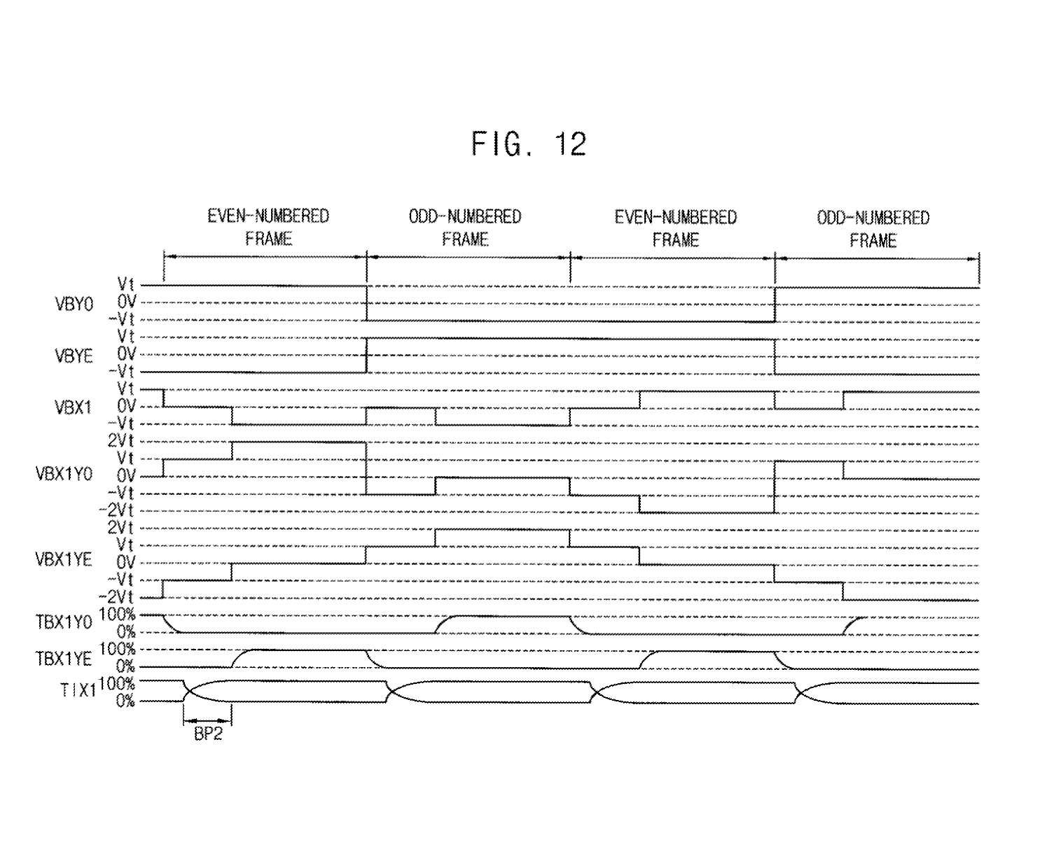

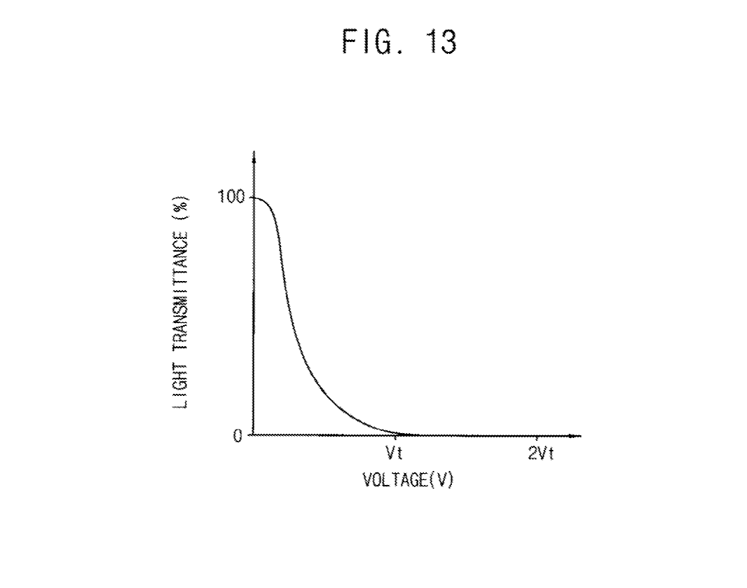

FIG. 11 is a diagram illustrating a scanning driving method for driving the display panel 200 illustrated in FIG. 9 and the barrier part 300A illustrated in FIG. 10. FIG. 12 is a waveform diagram illustrating the barrier driving signals outputted from the barrier driver 600 illustrated in FIG. 1 or FIG. 8 for driving the barrier part 300A. FIG. 13 is a graph illustrating light transmittance according to a voltage of the barrier part 300A illustrated in FIG. 10.

Referring to FIG. 11, the scanning direction of the display panel 200 is the second direction D2 (illustrated in FIG. 9) in an embodiment. Accordingly, display panel 200 is scanned in a vertical direction.

Referring to an ending period of the odd-numbered frame, the first image IO is displayed on the display panel 200. The first image data IO includes the first left image LO and the first right image RO.

Referring to a beginning period of the even-numbered frame, the second image IE is displayed on an upper portion of the display panel 200 that corresponds to a beginning portion of the scanning direction. The second image data IE includes the second right image RE and the second left image LE. At least a portion of the first image IO is still displayed on a lower portion of the display panel 200 that corresponds to an ending portion of the scanning direction.

In the unit pixels on the upper portion of the display panel 200, the image data (i.e., data voltages) received by the unit pixels is changed from data associated with the first image IO to data associated with the second image IE. When a data voltage is charged or discharged in the unit pixel, accurate data may not be displayed due to a transient response of the liquid crystal layer of the display panel 200. For example, the first image IO and the second image IE may be mixed in the unit pixels on the upper portion of the display panel 200 so that a crosstalk, which means that a left image is shown in the right eye and/or a right image is shown in the left eye, may occur if display of the images is not properly controlled.

In one or more embodiments, the barrier driver 600 controls a first set of the barrier part 300A, which corresponds to the upper portion of the display panel 200, to have the blocking state during an early scanning period BP2 of the unit pixels on the upper portion of the display panel 200 so that the crosstalk may be prevented. The early scanning period BP2 during which the first set of barriers of the barrier part 300A has the blocking state corresponds the transient response period of the liquid crystal layer of the display panel 200.

Referring to a middle period of the even-numbered frame, the second image IE is displayed on an upper portion and a central portion of the display panel 200 that correspond to the beginning portion and a middle portion, respectively, of the scanning direction. The first image IO is still displayed on a lower portion of the display panel 200 that corresponds to the ending portion of the scanning direction.

In the unit pixels on the central portion of the display panel 200, the image data received by the unit pixels is changed from data associated with the first image data IO to data associated with the second image IE. The first image IO and the second image IE may be mixed in the unit pixels on the central portion of the display panel 200 so that a crosstalk may occur if display of the images is not properly controlled.

In one or more embodiments, the barrier driver 600 controls a second set of barriers of the barrier part 300A, which corresponds to the central portion of the display panel 200, to have the blocking state during an early scanning period BP2 of the unit pixels on the central portion of the display panel 200 so that the crosstalk may be prevented. The early scanning period BP2 during which the second set of barriers of the barrier part 300A has the blocking state corresponds the transient response period of the liquid crystal layer of the display panel 200.

Referring to an ending period of the even-numbered frame, the second image IE is displayed on substantially the entire area of the display panel 200.

In the unit pixels on the lower portion of the display panel 200, which corresponds to the ending portion of the scanning direction, image data received by the unit pixels is changed from data associated with the first image IO to data associated with the second image IE. The first image IO and the second image IE may be mixed in the unit pixels on the lower portion of the display panel 200 so that a crosstalk may occur if display of the images is not properly controlled.

In one or more embodiments, the barrier driver 600 controls a third set of barriers of the barrier part 300A, which corresponds to the lower portion of the display panel 200, to have the blocking state during an early scanning period BP2 of the unit pixels on the lower portion of the display panel 200 so that the crosstalk may be prevented. The early scanning period BP2 during which the third set of barriers of the barrier part 300A has the blocking state corresponds the transient response period of the liquid crystal layer of the display panel 200.

FIG. 12 illustrates voltages applied to the electrodes BX1, BY1, BY2, etc. (illustrated in FIG. 10) to operate the scanning driving method discussed with reference to FIG. 11. FIG. 12 further illustrates transmittances of the barriers associated with the electrodes BX1, BY1, BY2, etc. according to the voltages applied to the BX1, BY1, BY2, etc. FIG. 7 further illustrates transmittances of the unit pixels corresponding to the barriers.

Referring to FIGS. 12 and 13, VBX1 represents a voltage applied to the BX1, i.e., one of the first plurality of electrodes illustrated in FIG. 10. VBYO represents a voltage applied to at least one of odd-numbered electrodes BY1, BY3, BY5, etc., of the second plurality of electrodes illustrated in FIG. 10. VBYE represents a voltage applied to at least one of even-numbered electrodes BY2, BY4, BY6, etc., of the second plurality of electrodes illustrated in FIG. 10.

For example, the same voltage VBYO may be applied to each of the odd-numbered electrodes BY1, BY3, BY5, etc., of the second plurality of electrodes. The same voltage VBYE may be applied to each of the even-numbered electrodes BY2, BY4, BY6, etc., of the second plurality of electrodes. The voltage VBYO applied to the odd-numbered\electrodes BY1, BY3, BY5, etc., of the second plurality of electrodes may be a voltage inverted from the voltage VBYE applied to the even-numbered electrodes BY2, BY4, BY6, etc., of the second plurality of electrodes.

Each of the VBX1, VBYO, and VBYE may have three levels. For example, each of the VBX1, VBYO, and VBYE may have values of about 0V, Vt, and −Vt.

VBX1YO is a voltage corresponding to VBYO−VBX1 (i.e., a value by which VBYO is greater than VBX1). VBX1YE is a voltage corresponding to VBYE−VBX1 (i.e., a value by which VBYE is greater than VBX1).

TBX1YO represents transmittances of a first plurality of barriers defined by the electrode BX1 of the first plurality of pixels and the odd-numbered electrodes BY1, BY3, BY5, etc., of the second plurality of electrodes. The transmittances of the first plurality of barriers TBX1YO are adjusted by VBX1YO. When VBX1YO has a voltage of about 0V, the transmittances of the first plurality of barriers TBX1YO are about 100% so that the first plurality of barriers has the transmitting state. When VBX1YO has a voltage of Vt or −Vt, the transmittances of the first plurality of barriers TBX1YO are close to 0% so that the first plurality of barriers has the blocking state. When VBX1YO has a voltage of 2 Vt or −2 Vt, the transmittances of the first plurality of barriers TBX1YO are about 0% so that the first plurality of barriers has the blocking state.

TBX1YE represents transmittances of a second plurality of barriers which are defined by the electrode BX1 of the first plurality of pixels and the even-numbered second electrodes BY2, BY4, BY6, etc., of the second plurality of electrodes. The transmittances of the second plurality of barriers TBX1YE are adjusted by VBX1YE. When VBX1YE has a voltage of about 0V, the transmittances of the second plurality of barriers TBX1YE are about 100% so that the second plurality of barriers has the transmitting state. When VBX1YE has a voltage of Vt or −Vt, the transmittances of the second plurality of barriers TBX1YE are close to 0% so that the second plurality of barriers has the blocking state. When VBX1YE has a voltage of 2 Vt or −2 Vt, the transmittances of the second plurality of barriers TBX1YE are about 0% so that the second plurality of barriers has the blocking state.

TIX1 represents transmittances of the unit pixels corresponding to the first plurality of barriers and the second plurality of barriers.

When display of images is changed from the odd-numbered frame is changed to the even-numbered frame, if the display of the images is not properly controlled, a crosstalk may occur at the unit pixels corresponding to the first plurality of barriers and the second plurality of barriers due to the transient response of the liquid crystal layer.

In one or more embodiments, as illustrated in the diagram associated with T1X1, the first plurality of barriers has the blocking state before the unit pixels begin to be scanned.

In addition, the second plurality of barriers enters the blocking state to maintain the blocking state during the early scanning period BP2. As can be appreciated from the discussion with reference to FIG. 11, the potential crosstalk during the early scanning period BP2 may be prevented.

According to one or more embodiments, the barrier part 300A is driven by the scanning driving method, and a selected set of the barrier has the blocking state during the early scanning period BP2, so that the potential crosstalk may be prevented. In addition, the light source part 100 is not required to be repetitively turned on and off to prevent the crosstalk, so that a luminance of the display panel may be maintained. Advantageously, 3D images with desirable display quality may be provided.

According to embodiments of the present invention as explained above, the barrier part of the display apparatus is driven by the scanning driving method, and a selected set of the barriers has the blocking state during the early scanning period, so that the potential crosstalk may be prevented. Advantageously, desirable 3D image display quality may be provided.

The foregoing is illustrative of the present invention and is not to be construed as limiting thereof Although a few embodiments of the present invention have been described, those skilled in the art will readily appreciate that many modifications are possible in the embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The present invention is defined by the following claims, with equivalents of the claims to be included therein.

What is claimed is:

1. A display apparatus for enabling a viewer to perceive a three-dimensional image, the display apparatus comprising:
a display panel including a unit pixel;
a display panel driver for providing image data to the display panel during a frame, the image data including first image data and second image data, the frame including a first sub-frame and a second sub-frame, the display panel driver being configured for providing the first image data to the display panel during the first sub-frame and being configured for providing the second image data to the display panel during the second sub-frame;
a barrier part including a plurality of barriers for adjusting presentation of a two-dimensional image displayed on the display panel to enable the viewer to perceive the three-dimensional image, the plurality of barriers including a first barrier and a second barrier neighboring the first barrier; and
a barrier driver for controlling the barrier part so that the first barrier permits transmission of first light during the first sub-frame and so that the second barrier permits transmission of second light during the second sub-frame.

2. The display apparatus of claim 1, wherein the first image data is configured for providing a first plurality of left image portions and a first plurality of right image portions that are alternately disposed with each other, and the second image data is configured for providing a second plurality of left image portions and a second plurality of right image that are alternately disposed with each other.

3. The display apparatus of claim 2, wherein
the first plurality of left image portions is shown to a left eye of the viewer during the first sub-frame,
the second plurality of left image portions is shown to the left eye of the viewer during the second sub-frame,
the first plurality of right image portions is shown to a right eye of the viewer during the first sub-frame, and
the second plurality of right image portions is shown to the right eye of the viewer during the second sub-frame.

4. The display apparatus of claim 1, wherein the barrier part includes a first barrier substrate, a second barrier substrate facing the first barrier substrate, and a barrier liquid crystal layer disposed between the first barrier substrate and the second barrier substrate.

5. The display apparatus of claim 1, wherein a width of the unit pixel in a first direction is substantially equal to a width of at least one of the first barrier and the second barrier in the first direction.

6. The display apparatus of claim 1, wherein
the barrier part drives the barrier part in synchronization with a scanning timing of the display panel, and
a set of barriers among the plurality of barriers blocks light transmission during a scanning period in the second sub-frame and permits light transmission after the scanning period in the second sub-frame.

7. The display apparatus of claim 6, wherein the scanning period corresponds to a transient response period of a liquid crystal layer of the display panel.

8. The display apparatus of claim 6, wherein
a scanning direction of the display panel is substantially same as a scanning direction of the barrier part, and
the scanning direction of the display panel is substantially perpendicular to an extending direction of the first barrier.

9. The display apparatus of claim 8, wherein the barrier part includes a first electrode, a plurality of electrodes, and a barrier liquid crystal layer disposed between the first electrode and the plurality of electrodes, and
an electrode of the plurality of electrodes extends in a direction substantially perpendicular to the scanning direction of the display panel.

10. The display apparatus of claim 9, wherein a same voltage is applied to the first electrode during both of the first sub-frame and the second sub-frame.

11. The display apparatus of claim 6, wherein
a scanning direction of the display panel is substantially same as a scanning direction of the barrier part, and
the scanning direction of the display panel is substantially same as an extending direction of a column of barriers among the plurality of barriers.

12. The display apparatus of claim 11, wherein
the barrier part includes a first plurality of electrodes, a second plurality of electrodes crossing the first plurality of electrodes, and a barrier liquid crystal layer disposed between the first plurality of electrodes and the second plurality of electrodes,
an electrode of the first plurality of electrodes extends in a direction substantially perpendicular to the scanning direction of the display panel, and
an electrode of the second plurality of electrodes extends in the scanning direction of the display panel.

13. The display apparatus of claim 12, wherein
a first voltage is applied to odd-numbered electrodes of the second plurality of electrodes, and
a second voltage is applied to even-numbered electrodes of the second plurality of electrodes.

14. The display apparatus of claim 13, wherein the first voltage is inverted with respect to the second voltage.

15. The display apparatus of claim 1, further comprising:
a viewpoint detecting camera for detecting a viewpoint of the viewer; and
a compensating part for compensating a barrier driving signal provided by the barrier driver based on the viewpoint of the viewer.

16. The display apparatus of claim 1, wherein each barrier of the plurality of barriers corresponds to an area at which an electrode of a first plurality of electrodes overlaps an electrode of a second plurality of electrodes.

17. The display apparatus of claim 1, wherein the display panel and the barrier part are rotatable for about 90 degree.

18. A method for enabling a viewer to perceive a three-dimensional image, the method comprising:
providing first image data to a display panel during a first sub-frame;
providing second image data to the display panel during a second sub-frame;
controlling a barrier part for adjusting presentation of a two-dimensional image displayed on the display panel to the viewer, the barrier part including a plurality of barriers, the plurality of barriers including a first barrier and a second barrier neighboring the first barrier;
controlling the first barrier such that the first barrier permits transmission of first light during the first sub-frame; and
controlling the second barrier such that the second barrier permits transmission of second light during the second sub-frame.

19. The method of claim 18, further comprising:
driving the barrier part in synchronization with a scanning timing of the display panel; and
controlling a set of barriers among the plurality of barriers such that the set of barriers blocks light transmission during a scanning period in the second sub-frame and permits light transmission after the scanning period in the second sub-frame.

20. The method of claim 19, wherein the scanning period corresponds to a transient response period of a liquid crystal layer of the display panel.

21. The method of claim 19, wherein
a scanning direction of the display panel is substantially same as a scanning direction of the barrier part, and
the scanning direction of the display panel is substantially perpendicular to an extending direction of the first barrier.

22. The method of claim 21, wherein
the barrier part includes a first electrode, a plurality of electrodes, and a barrier liquid crystal layer disposed between the first electrode and the plurality of electrodes, and
an electrode of the plurality of electrodes extends in a direction substantially perpendicular to a scanning direction of the display panel.

23. The method of claim 19, wherein
a scanning direction of the display panel is substantially same as a scanning direction of the barrier part, and
the scanning direction of the display panel is substantially same as an extending direction of a column of barriers among the plurality of barriers.

24. The method of claim 23, wherein the barrier part includes a first plurality of electrodes, a second plurality of second electrodes crossing the first plurality of electrodes, and a barrier liquid crystal layer disposed between the first plurality of electrodes and the second plurality of electrodes,
an electrode of the first plurality of electrodes extends in a direction substantially perpendicular to the scanning direction of the display panel, and
an electrode of the second plurality of electrodes extends in the scanning direction of the display panel.
